(19) United States
(12) Patent Application Publication
(10) Pub. No.: US 2007/0169626 A1
(43) Pub. Date: Jul. 26, 2007

(54) Apparatus and method of cleansing contaminated air using microwave radiation

(76) Inventor: Thomas M. Sullivan, Indianapolis, IN (US)

Correspondence Address: CLARK & BRODY, 1090 VERMONT AVENUE, NW, SUITE 250, WASHINGTON, DC, 20005, US

(21) Appl. No.: 10/589,948

(22) PCT Filed: Feb. 15, 2005
(86) PCT No.: PCT/US05/04770

§ 371 Date: Aug. 18, 2006

Related U.S. Application Data
(60) Provisional application No. 60/545,927, filed on Feb. 20, 2004.

(51) Int. Cl. B03C 3/00

(52) U.S. Cl. 96/15

(57) ABSTRACT

An air conditioning system uses microwaves to effectively destroy airborne contaminants. In one mode, air (8) is passed through a microwave-transparent tube (6) and is subjected to microwaves in the presence of one or more of water, water vapor, steam or hydrogen to cause destructive dipole polarization, electrical coupling, hydrolysis, and/or interfacial polarization of the contaminants or impurities found in the air (8). In another mode, solids or liquids are decontaminated by subjecting the objects to microwaves. Paramagnetic dust particles in the air, especially underground railway air, can also be removed using an electromagnet.

### FIELD OF THE INVENTION

This invention relates to conditioning air and to the cleaning of objects to remove objectionable components suspended in motile air or adhering to surfaces.

### BACKGROUND ART

Air quality is adversely affected by the presence of bacteria, viruses, fungal metabolites, spores, proteins, and an increasing myriad of volatile chemicals. Dust emanating from steel or cast iron abrading against steel can further degrade air quality as finely divided, surface-active particles are generated. Solid particles or microscopic biological contaminants can move through an area suspended in air or can be brought into a space on solid surfaces or among the recesses and interstices of garments or documents.

It is well known to one skilled in the art that the usefulness of cleanrooms used for medical purposes and for the manufacture of semiconductors is dependent upon air quality. Furthermore, confined spaces like railway cars, aircraft fuselages, and automobile interiors, may degrade in commercial viability as air quality degrades.

Underground railways generate dust from the constant abrasion of steel wheels against steel rails. Steel or iron dust is paramagnetic and may be reduced to particle sizes which are too small in size for all but HEPA filters, but too high in overall volume to be practically addressed by such high efficiency filters.

Variations of four basic methods have historically been used to control air quality. They include: 1) physical impaction on filters, 2) electrostatic precipitation of particles, 3) absorption of gases by solid sorbents, and 4) chemical reaction such as ozonation or ultraviolet light to convert particles or volatile chemicals to less objectionable products. Each method is deficient in some respect.

Physical impaction on filters is limited by the pore size of the filters. HEPA filters have pore sizes down to 0.03 microns, but viruses can be as small as 0.003 microns, an order of magnitude smaller. Dust particles can also be smaller than the average pore size of the filters. In addition to limitations imposed by pore size, filters cause pressure to drop as flow is restricted and may not be able to handle very large amounts of very fine dust.

Electrostatic precipitation of particles works by first charging particle then drawing them to oppositely charge collection plates. This method has difficulty coping with high velocity air streams and has no capability to deal with volatile chemicals or difficult to charge particles.

Adsorption of gases by sorbents only works efficiently when the sorbent is specifically matched to the gases. Activated charcoal, a commonly used sorbent, requires that carbon particle characteristics be matched to the properties of the gases to be adsorbed. Adsorption also requires some measure of contact and can entail significant pressure drop.

Chemical reaction using ozone generated by electric discharge or by ultraviolet light is a very slow process due to the very low concentration of ozone in air and is unable to efficiently decontaminate high velocity air flow.

A variety of strategies have been developed to offset the shortcomings of the previously mentioned four methods. Usually they represent a combination of the methods.

U.S. Pat. No. 5,938,823 describes an electrostatic precipitator method in which the collector plates are constructed of a semiconductive surface that absorbs microwaves so that it is heated and destroys biological contaminants. The inventor does not address the issue of biological contaminants or volatile chemicals in the airstream, which do not contact the collector plate. Though the inventor claims “a selectively operable microwave source,” microwave frequencies are not mentioned. Indeed, the inventor describes an example of a collector plate achieving 500° F. as evidence of the capacity of the system to destroy biological contaminants thermally without recognizing that contaminants themselves may act like nodes or anti-nodes to attenuate microwaves. The inventor states that “According to the present invention a microwave absorbing collector plate of an electrostatic precipitator serves as a heat generator for heating captured particulate matter sufficiently to sterilize and/or disinfect microorganisms.” Microwaves operate intermittently as needed to heat the collector plates to a desired temperature.

Biological contaminants may include spores having “carapace” outer structures. Spores with carapaces can be notoriously resistant to high temperature surfaces and have been shown to resist burning. Air purification technologies dependent upon momentary contact with hot “collector plates” offer no assurance of reliably decomposing spores.

### SUMMARY OF THE INVENTION

It is the object of the present invention to couple microwaves to contaminants so that resonance of the contaminants themselves converts the contaminants to relatively innocuous products without requiring physical contact or heating of the airstream as a whole. Only contaminants are heated, not the airstream as a whole because air does not resonate significantly when exposed to microwaves at the frequencies of interest.

Furthermore it is the object of the present invention to not impose a pressure drop on the air passing through the system. Larger air volumes carrying more contaminants merely require more microwave power. With respect to the present invention, air velocity is not an issue except for the general function of the air conditioning system as a whole as would be known to one skilled in the art.

Contaminants lodged in and on solid objects including documents, garments, and microwave permeable structural materials are as readily resonated or attenuated as those suspended in flowing air. Documents or garments are placed in a microwave and exposed to microwaves at a sufficient power level and for a sufficient duration of time to decompose contaminants depending on the volume and composition of the contaminants. Garments comprising synthetic and natural fibers do not significantly couple with or attenuate microwaves at the frequencies claimed herein.

It is furthermore an object of the present invention to control the concentration of microscopic paramagnetic iron particles from an airstream by using an electromagnet without imposing a significant pressure drop on the airstream. Magnetic flux is shielded so that it is not problematic to nearby people or systems.

In satisfaction of the foregoing objects and advantages, and in one mode, the invention includes an apparatus for cleansing air, comprising a source of microwaves that couples with or attenuates contaminants or in air to cause destructively resonant vibrations and to cause destructive dipole polarization, electrical coupling, hydrolysis, and/or interfacial polarization of the contaminants or impurities. A tube or other containment structure is provided through which air passes as it is exposed to the microwaves. The containment structure is made from materials, which are invisible or nearly invisible to the microwave frequencies resonant vibrations. A gas permeable material covers each end of the tube. The containment structure can be made from materials selected from the group consisting of alumina, Pyrex® glass, quartz, sapphire, silicon nitride, or polymer.

The air is treated with the microwaves in the presence of one or more of water, water vapor, steam, or hydrogen for destruction of the contaminants as described above. If water is employed, the source of water can be found in the air itself, or via an outside source of the water, water vapor, steam, or alternatively, hydrogen can be supplied in the appropriate amount lieu of water.

The surface of the containment structure in contact with the contaminated gas, in a preferred mode, comprises yttrium oxide, rare earth oxides, carbon, iron, or titanium oxide, as these materials act as catalysts and enhance the destruction of the contaminants/impurities. Iron and carbon particles in air can also act like homogenous catalysts to increase the reaction rate of biological or chemical contaminants with water, water vapor, steam and/or hydrogen.

A preferred source of the microwaves uses a microwave frequency between 433 and 435 MHz, 902 MHz and 928 MHz or 2.4 and 2.5 GHz.

The gas permeable material can be one of a screen material, perforated metal, or wire mesh. The gas permeable material has openings sufficiently small enough to prevent radiation leakage. The gas permeable material can also have a surface comprised of a metal from Group VIII of the Periodic Table or carbon to act as a catalyst, and when choosing the metal, it is preferably palladium or platinum.

The impurities/contaminants can be virtually any type, but preferred impurities or contaminants comprise bacteria, viruses, fungal metabolites, spores, volatile chemicals and proteins. More preferred agents to be treated include spores as endospore-forming bacillus, bacteria as clostridium botulinum, protein as ricin, prion-containing proteins, and volatile chemicals such as organofluorophosphonate acid esters, organothiophosphonate acid esters, 1,1′-thiobis[2-cloroethane], 2-cloro-N-(2-cloroethyl)-methylethanamine, and dichloro(2-chlorovinyl)arsine.

The invention also treats contaminants/impurities found on or in one or more solids or liquids. In this mode, the apparatus for cleansing solids or liquids comprises a housing including a source of microwaves that couples with or attenuates contaminants or impurities on the surface of, within the recesses or interstices of, or surrounded by solid objects, which are microwave permeable or contained in the liquids to cause destructively resonant vibration. The materials are contained in a microwave reflective enclosure that has a passageway to atmosphere. The passageway is covered by a gas permeable material that has opening sized to prevent escape of microwaves from the enclosure. The passageway allows for thermal expansion within the microwave-radiated atmosphere.

Similar to the method of treating contaminated air, the solids are subjected to the microwaves in the presence of one or more of water, water vapor, steam, or hydrogen, and if water is the preferred destroying agent and insufficient water is in the treating atmosphere, a source of water, water vapor or steam, can be provided, or hydrogen can be provided if this is the preferred hydrolyzing agent. Non-aqueous liquids would also require the presence of these agents, with aqueous liquids containing sufficient amounts of their own water for destruction of the contaminants.

A supportive structure can also be provided within the housing to support the one or more solids or liquids during treatment, the supportive structure being invisible or nearly invisible to microwaves. As with the continuous-type air treatment apparatus, preferred frequencies for batch treating of solid objects are between 433 and 435 MHz, 902 MHz and 928 MHz and between 2.4 and 2.5 GHz. The solids or liquids can be virtually any type, with preferred classes of solid objects including paper or paper-containing objects, garments, fabrics, wood, concrete, bricks, concrete blocks, earth, stone, wood, and foods such as meat, and preferred liquids being waste liquids such as contaminated water derived from a contaminated site clean up.

The supportive structure can be a tray or pan and be made from one of alumina, Pyrex® glass, quartz, sapphire, silicon nitride, or polymer.

The gas permeable materials described above as well as the catalyst can also be utilized in the batch treatment process. The solids or liquids can also be treated in a continuous manner using material handling equipment, and the necessary sealing at entrance and exits to assure that microwaves do not escape.

The invention also includes a method of treating air containing paramagnetic dust particles, as is commonly found in underground railway sites. In this mode, the method comprises providing a stream of air that contains the paramagnetic dust particles. An electromagnet is provided and positioned so that the stream of air passes through the electromagnetic flux created by the electromagnet to remove the dust particles from the air stream. Magnetic shielding materials can be used to shield the electromagnet so that only the stream of air is subjected to the electromagnetic flux. This embodiment can be used in a stand alone manner, coupled with the microwave treatment apparatus, or some other conventional air conditioning systems.

Preferably, the air being treated is that found in underground railways since these areas contain the paramagnetic dust particles from various metals contacting other metals. The shielding can also be used to protect passengers in the railway.

### BRIEF DESCRIPTION OF THE DRAWINGS

Reference is now made to the drawings of the invention wherein:

FIG. 1 shows a schematic arrangement of one embodiment of the invention;

FIG. 2 shows a schematic arrangement of another embodiment of the invention; and

FIG. 3 shows an exemplary arrangement of a yet another embodiment of the present invention.

### DESCRIPTION OF THE PREFERRED EMBODIMENTS

The present invention offers a significantly improved way to cleanse air that contains contaminants. These contaminants can take on any form in terms of bacteria, viruses, and the like. The invention uses microwave energy to effectively destroy the contaminants via resonance. The invention can treat contaminated air in a continuous fashion whereby air passing through a tube that is essentially transparent to microwave propagation is subjected to the microwaves. Contaminants entering the tube are rendered harmless by the microwaves. Since the contaminants do not constitute a large percentage of the air volume, collection treatment downstream of the tube is generally unnecessary.

The invention uses the same principle to effectively destroy contaminants on solid or liquids by containing and/or placing the objects in a housing or chamber and subjecting the objects to the same microwaves.

A preferred embodiment of the present invention comprises using a 433-35 MHz, 902-928 MHz 902-928 MHz or 2.4-2.5 GHz frequency magnetron. The magnetron is so configured as to expose the contents of a round tube or other containment structure made from materials, which are invisible or nearly invisible to the previously mentioned microwave frequencies. The containment structure is located in a container that reflects the microwaves. Screens, perforated plates, or the like which are permeable to air cover each end of the round tube to enable air to pass into the tube from one end and exit from the other without microwave leakage. In this manner, air laden with contaminants like bacteria, viruses, and the like flows through a screen and into a tube where microwaves couple with the contaminants and water in the air and convert the mixture to harmless, unoffensive byproducts. One skilled in the art will recognize that the residence time of contaminant laden air in the tube is a function of the contaminant species in relation to coupling or attenuating efficiency at a particular frequency and the power level of the magnetron source in the context of arbitrarily selected standards of quality for the air after microwave treatment. In addition, the manner in which the contaminated gas is supplied to the containment structure can be any type so long as the gas is directed through the containment structure for treatment. Likewise, collection of the exiting and treated gas can be done in any fashion, or the gas can be merely exhausted to atmosphere.

The containment structure can be made from a multitude of materials, which are penetrated to great depth by microwaves and well known to one skilled in the art. A tube, more preferably a round tube is preferred as the containment structure, but non-round cross section shapes could be used. Preferably, the containment structure is made from high purity aluminum oxide, Pyrex glass, quartz, sapphire, silicon nitride, or polymer.

If so desired, the outlet screen can be made from or covered with a metal catalyst taken from Group VIII of the Periodic Table or carbon to accelerate the hydrolytic decomposition of contaminants. Preferably, the outlet screen includes a eutectic mixture composed primarily of palladium, to facilitate half reactions in the formation of reaction co-products which are not objectionable.

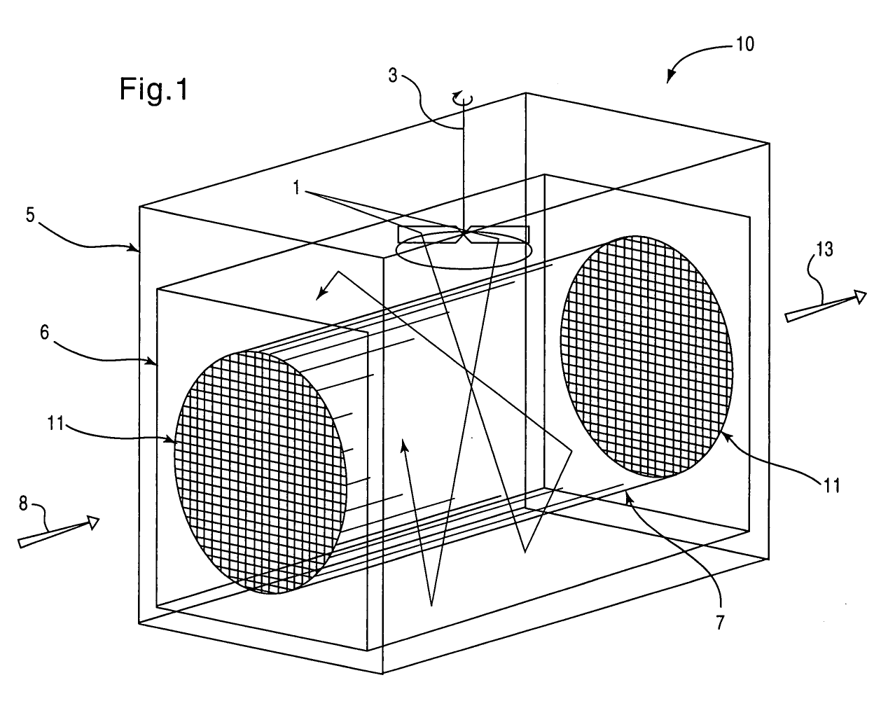

FIG. 1 depicts an apparatus 10 of the present invention in which microwaves from a microwave emitter 1 are reflected and redirected continuously by a rotating stirrer 3 into an outer box 5 to contain the microwaves. Microwaves are continuously reflected in an inner box 6 and pass through a gas containing tube 7 contained therein. The microwaves are absorbed by contaminants in air 8 passing through the tube 7. Air entering the gas containing tube 7 within the microwave atmosphere passes through finely divided metal surfaced screen 11 and out of the gas containing tube 7 through another finely divided metal surfaced screen 11. The screen openings are sized to prevent escape of microwaves from the tube 7. Decontaminated air 13 exits the screen 11, and can be discharged to atmosphere.

The contaminant-containing air is subjected to the microwaves in the presence of one or more of water, water vapor, steam, or hydrogen for destruction of the contaminants. The water can be available in the contaminant-containing air, or supplied from an outside source. If hydrogen is used, it would normally be provided from an outside source.

Another embodiment of the present invention involves purifying garments or documents or other solid objects that may contain contaminants, or liquids, such as those that may be derived from a contaminated clean up site. Again, a 433 to 435 MHz, 902-928 MHz or 2.4-2.5 GHz frequency magnetron is so configured that microwaves emanating from this magnetron pass through garments or documents or liquids, which may have include bacteria, viruses, fungal metabolites, spores, proteins, or volatile chemicals, or the like. Solids/liquids that are supported on or contained in a tray, pot, or pan made from a material, like the previously mentioned tube, which is penetrated to great depth by the microwave frequencies of interest and is essentially invisible to microwaves. As with the air treatment apparatus, water and hydrogen may be continuously added to facilitate destruction of the contaminants if appropriate, especially if insufficient water is available in the treatment atmosphere. The amount of water, whether it be in the form of steam, water, or water vapor and/or hydrogen, if used, should be at least on a 1:1 molar ratio basis with any amide radical groups found in the contaminant/impurity. The hydrogen should be no greater than 4% by volume of the atmosphere in the treatment space. The hydrogen and water can be introduced together or separately, and done in any conventional fashion.

A structure such as a container, e.g., a tray, pan, pot, or the like is configured to support garments, paper products such as envelops, documents or other objects or liquids and is located in a microwave reflective box which is itself located within an outer box that contains all microwaves and prevents leakage to the atmosphere. Other examples of solid objects that can be treated include concrete, bricks, concrete blocks, earth, stone, wood, and food such as meat, with preferred liquids being waste water derived from a contaminated site clean up. It will be recognized that documents, garments, woven fabrics, and other solid objects or liquids may be continuously carried through the chamber by systems like conveyors or pumps and pipelines which are well known to one skilled in the art. These material handling systems would also include the necessary sealing features to assure that microwave radiation does not escape with the continuous entry and exit of solid objects.

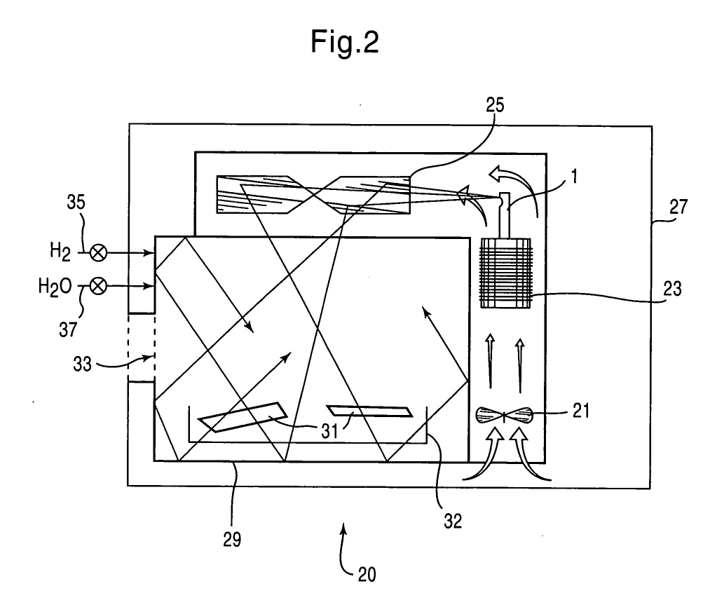

FIG. 2 shows an exemplary microwave system 20 for decontaminating solid objects. The system includes a blower fan 21 that directs cooling air over a magnetron 23, and stirrer 25, all positioned in an outer box 27. Microwaves are continuously reflected by the stirrer 21 into a microwave reflecting metal case 29 which may contain solid objects 31. Microwaves penetrate and decontaminate the solid objects 31. Air and gases exit the microwave atmosphere in the metal box through a finely divided metal screen 33. If required, sources of hydrogen and water, water vapor or steam are shown as 35 and 37. The microwave reflective box 29 may include a supportive structure such as a tray or pan 32 to support the solid objects. The supportive structure should be invisible or nearly invisible to the microwaves so that the objects are maximally exposed to the microwaves during the treatment cycle. Liquids such as waste water derived from the clean up of a contaminated site can also be treated by placing the water in the supportive structure and exposing it to the microwaves. Since water is present with the contaminants, there is no need for the addition of water, water vapor, steam or hydrogen.

Examples of impurities/contaminants found in air or in or on solids and/or liquids and which can be treated by the invention include bacteria, viruses, fungal metabolites, spores, volatile chemicals, and proteins. Specific examples in include ricin, proteins with prion, bacteria such as Clostridium botulinum, spores such as endospore-forming bacillus. Volatile chemicals can include organofluorophosphonate acid esters, organothiophosphonate acid esters, 1,1′-thiobis[2-cloroethane], 2-cloro-N-(2-cloroethyl)-methylethanamine, and dichloro(2-chlorovinyl)arsine.

It is believed that microwaving these contaminants causes destructive dipole polarization, electrical coupling, hydrolysis, and/or interfacial polarization. The contaminants could be found on the objects or in interstices or recesses thereof or are airborne, or in liquids.

Another aspect of the invention involves cleansing air that contains amounts of paramagnetic iron dust particles. In this embodiment of the present invention, a microwave air conditioner may be used upstream in a ventilation system preceded by an electromagnetic plate that attracts and holds iron particles suspended in ventilation air until they are released by terminating electric power to the electromagnet. In an alternative use, the microwave air conditioner can be used on its own to treat the dust-laden air.

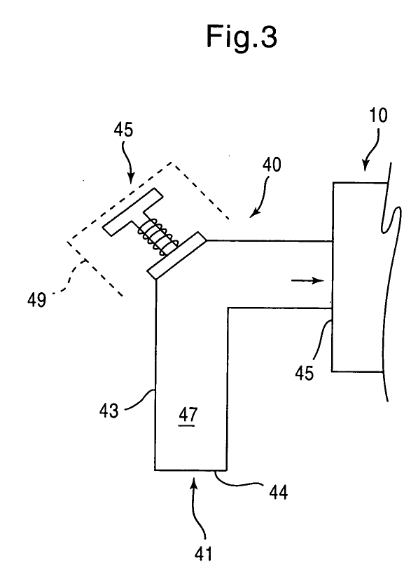

The air conditioner uses an electromagnet that is positioned or configured such that air intended to be treated is passed by the electromagnet. In this way, the electromagnetic flux attracts the paramagnetic iron dust particles in the air, thus leaving the air free of these materials. The particles can then be collected at the appropriate time by depowering the electromagnet. FIG. 3 shows an exemplary apparatus 40, wherein the contaminated air 41 enters an elbow 43 at entrance 44. An electromagnet 45 is positioned to collect the paramagnetic dust so that dust-free air exits the system at 45. It is preferred to position the electromagnet 43 above the vertical leg 47 of the elbow 40 so that once it is depowered, the collected dust falls vertically and can be collected at or below the entrance 44 with any conventional collecting means such as a tray, vacuum or the like. This embodiment can be linked to the apparatus 10 shown in FIG. 1, if so desired. Alternatively, the system can be used as a precursor to any other air treatment system, or used on its own.

The electromagnet preferably using magnetic shielding materials, which are represented by the hatching 49 so that the flux is concentrated on the air stream being treated, and other nearby systems, devices, or people are protected from the flux.

The invention also entails methods of destroying the contaminants/impurities using the apparatus described above. Referring to the FIG. 1 embodiment, the contaminated air is provided and passed through the containment structure so that it can be treated by the microwaves to cause destructive dipole polarization, electrical coupling, hydrolysis, and/or interfacial polarization of the contaminants or impurities. The contaminated air should either inherently contain sufficient water to effect hydrolysis and the other mechanisms involved in destroying the contaminants, or water, water vapor, steam and/or hydrogen in the appropriate amount could be added to the contaminated air being treated for contaminant destruction. The decontaminated air then exits the containment structure. The contaminated air may also contain catalytic quantities of iron and/or carbon in the form of fine dust or particles, e.g., underground railway environments, and these substances assist in the hydrolytic decomposition of the contaminants being treated.

Similarly, the solid objects believed to be contaminated are placed on the support structure and subjected to the microwaves, in the presence of sufficient moisture, or added moisture if necessary for contaminant destruction. Hydrogen can also be added to the air-containing atmosphere enveloping the solid objects for purposes of contaminant destruction. The water and hydrogen amounts are preferably at a 1:1 molar ratio based on the presence of amide radical groups in the contaminants/impurities being destroyed. If there is sufficient humidity in the air, addition of water, water vapor or steam may not be required. Likewise, the use of hydrogen is optional if water is present, although its presence increases the rate of destruction significantly, e.g., up to four times as fast. Preferably, the hydrogen is limited to no more than 4% by volume of the atmosphere for safety concerns. The source of water, water vapor and steam, as well as the hydrogen can be from any conventional source, and these materials are desirable for their ability to permeate a number of different materials, e.g., paper.

It is also believed that liquids can be treated according to the invention, particularly liquids that may contain the contaminants of interest when they are derived from a clean up from a contaminated site. These liquids can be treated by subjecting them to the microwaves to achieve the same effects outlined above for gases and solids. Since these liquids normally would contain water, the addition of water, water vapor, steam or hydrogen would not be necessary, although in some instances, the liquids may be non-aqueous, and the agents may be required.

As such, an invention has been disclosed in terms of preferred embodiments thereof, which fulfills each and every one of the objects of the present invention as set forth above and provides a new and improved system for conditioning air.

Of course, various changes, modifications and alterations from the teachings of the present invention may be contemplated by those skilled in the art without departing from the intended spirit and scope thereof. It is intended that the present invention only be limited by the terms of the appended claims.

1. An apparatus for cleansing air, comprising:
a) a source of microwaves that couples with or attenuates contaminants or impurities in air to cause destructively dipolar polarization, electrical coupling, hydrolysis, and/or interfacial polarization of the contaminants:
b) a contaminant containment structure housed by a microwave-reflective enclosure having opposing ends, gas containing the contaminants or impurities passing through the contaminant containment structure and microwave reflective enclosure as the gas is exposed to microwaves, the contaminant containment structure being made from materials which are invisible or nearly invisible to the microwave frequencies;
c) a gas permeable material covering each end of the microwave-reflective enclosure, the gas permeable material having openings of a size that prevent microwaves to escape.

2. An apparatus for cleansing one or more solids or liquids, comprising:
a) a housing including source of microwaves that deeply penetrates and is directly absorbed by contaminants or impurities on the surface of, within the recesses or interstices of, or surrounded by solid objects which are microwave permeable or by contaminants or impurities contained in the liquids to cause destructive dipole polarization, electrical coupling, hydrolysis, and/or interfacial polarization of the contaminants or impurities,
b) microwave-reflective enclosure for containing the one or more solids or liquids, and a supportive structure within the housing and sized to hold at least liquids being treated, the supportive structure made from materials which are invisible or nearly invisible to the microwave frequencies; and
c) a passageway in the microwave reflective enclosure and a gas permeable material covering the passageway, the gas permeable material having openings too closely spaced to permit microwaves to escape, the passageway allowing thermal expansion within the microwave radiated atmosphere;
d) optionally a source of water, water vapor, steam, or hydrogen if the atmosphere in the enclosure or the liquids do not include a sufficient quantity of water.

3. The apparatus of claim 1, wherein the source of microwaves uses a microwave frequency between 433 and 435 MHz, 902 MHz and 928 MHz, or 2.4 and 2.5 GHz.

4. The apparatus of claim 1, wherein the contaminant containment structure is made from materials selected from the group consisting of alumina, Pyrex® glass, quartz, sapphire, silicon nitride, or polymer.

5. The apparatus of claim 2, wherein the support structure is made from materials selected from the group consisting of alumina, Pyrex® glass, quartz, sapphire, silicon nitride, or polymer.

6. The apparatus of claim 1, wherein gas permeable material is one a screen material, perforated metal, or wire mesh.

7. The apparatus of claim 1, wherein gas permeable material is covered with a metal catalyst taken from Group VIII metal of the Periodic Table.

8. The apparatus of claim 1, wherein a surface of the contaminant containment structure in contact with contaminated air includes one of yttrium oxide, carbon, iron, a rare earth oxide, or titanium oxide.

9. The apparatus of claim 1, further comprising a source of one or more of water, water vapor, steam or hydrogen for addition to the air.

10. The apparatus of claim 9, wherein the hydrogen is up to 4% of the atmosphere within the housing.

11. The apparatus of claim 2, wherein the supportive structure is a container adapted to hold one or more of the solids or liquids.

12. A method of destroying contaminants in air comprising:
a) providing a source of contaminated or impurity laden air; and
b) subjecting the air to microwaves in the presence of one or more of water, water vapor, steam, or hydrogen for dipole polarization, electrical coupling, hydrolysis, and/or interfacial polarization of the contaminants.

13. A method of destroying contaminants/impurities on one or more solids or liquids comprising:
a) providing one or more contaminated or impurity laden solids or liquids;
b) placing at least the one or more contaminated or impurity laden liquids in a supportive structure;
c) subjecting the one or more solids or liquids to microwaves for dipole polarization, electrical coupling, hydrolysis, and/or interfacial polarization of the contaminants/impurities associated with at least the one or more solids being in the presence of water, water vapor, or steam, or hydrogen.

14. The method of claims 12, wherein the impurities or contaminants comprise bacteria, viruses, fungal metabolites, spores, volatile chemicals and proteins.

15. The method of claims 12, wherein one or more of the following apply:
the spores are formed by endospore forming bacillus, the bacteria is clostridium botulinum, the protein is ricin, the proteins include prions, and the volatile chemicals comprise organofluorophosphonate acid esters, organothiophosphonate acid esters, 1,1′-thiobis(2-cloroethane), 2-cloro-N-(2-cloroethyl)-methylethanamine, and dichloro(2-chlorovinyl)arsine.

16. The method of claim 12, wherein the contaminated air contains one or more impurities that increase the rate of hydrolysis.

17. The method of claim 16, wherein the impurity comprises one or both of carbon- or iron-containing materials.

18. The method of claims 12, wherein a molar ratio of water and/or hydrogen to an amide-radical group found in the contaminant/impurity is at least one to one.

19. The method of claims 12, wherein hydrogen in the atmosphere comprises up to 4% by volume.

20. The method of claim 13, wherein the solids further comprise paper or paper-containing objects, garments, fabrics, wood, concrete, bricks, concrete blocks, earth, stone, wood, and foods such as meat, and the liquids comprise waste water derived from a contaminated site clean up.

21. The method of claim 12, further comprising adding an amount of one or more of water, water vapor, steam, or hydrogen to the atmosphere.

22. The method of claims 12, further comprising introducing a metal catalyst from Group VII of the Periodic Table or carbon during the subjecting step.

23. The method of claim 22, wherein the metal catalyst from Group VII of the Periodic Table or carbon is included with the gas permeable material.

24. An apparatus for treating paramagnetic dust, particularly in underground railways comprising:
a) a source of paramagnetic dust-containing air;
b) ductwork having an entry for receiving the paramagnetic dust-containing air and an exit for discharging essentially dust free air;
c) an electromagnet positioned adjacent the ductwork and between the entry and exit for collecting the paramagnetic dust when powered.

25. The apparatus of claim 24, wherein the ductwork is in the shape of an elbow with one generally vertical leg, the generally vertical leg containing the entry, the electromagnet positioned at the direction change of the elbow, so that depowering of the electromagnet releases collected paramagnetic dust for collection at the entry of the elbow.

26. A method of cleansing contaminated air containing paramagnetic dust particles comprising:
a) providing a stream of air that contains the paramagnetic dust particles;
b) providing an electromagnet;
c) passing the stream of air through an electromagnetic flux generated by the electromagnet to remove the paramagnetic dust particles from the stream; and
d) optionally depowering the electromagnet to release the removed paramagnetic dust for collection.

27. The method of claim 26, further comprising shielding the electromagnet using magnetic shielding materials so that only the stream of air is subjected to the electromagnetic flux.

28. The method of claim 26, wherein the stream of air comes from an underground railway.

29. The method of claim 26, wherein the magnetic shielding materials are used to protect rail passengers in the underground railway.
